(19) United States
(12) Patent Application Publication
(10) Pub. No.: US 2006/0153300 A1
(43) Pub. Date: Jul. 13, 2006

(54) Method and system for motion vector prediction in scalable video coding

(75) Inventors: Xianglin Wang, Irving, TX (US); Yiliang Bao, Coppell, TX (US); Marta Karczewicz, Irving, TX (US); Justin Ridge, Sachse, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/330,703

(22) Filed: Jan. 11, 2006

Related U.S. Application Data
(60) Provisional application No. 60/643,464, filed on Jan. 12, 2005.

(51) Int. Cl. H04N 11/02; H04N 7/12; H04B 1/66; H04N 11/04

(52) U.S. Cl. 375/240.16; 375/240.08

(57) ABSTRACT

In scalable video coding where two predictive motion vectors are calculated: one from the current layer neighboring motion vectors and one from the co-located base layer motion vectors. One of the two predictive motion vectors is chosen as the predictive motion vector for current block. A flag bit is coded to indicate which predictive motion vector is chosen only if it is not possible to infer the layer from which the predictive motion vector for the current block comes. Such inference is possible in many situations, such as when both predictive motion vectors are substantially the same, or only one of the vectors is reliable or available.

### CROSS REFERENCE TO RELATED APPLICATION

This patent application is based on and claims priority to U.S. provisional patent application No. 60/643,464, filed Jan. 12, 2005.

The present invention is related to a co-pending U.S. patent application Ser. No. 10/891,430, filed Jul. 14, 2004, assigned to the assignee of the present invention.

### FIELD OF THE INVENTION

This invention relates to the field of video coding and, more specifically, to scalable video coding (SVC).

### BACKGROUND OF THE INVENTION

For storing and broadcasting purposes, digital video is compressed, so that the resulting, compressed video can be stored in a smaller space or transmitted with a more limited bandwidth than the original, uncompressed video content.

Digital video consists of sequential images that are displayed at a constant rate (30 images/second, for example). A common way of compressing digital video is to exploit redundancy between these sequential images (i.e. temporal redundancy). In a typical video at a given moment, there exists slow or no camera movement combined with some moving objects. Since consecutive images have very much the same content, it is advantageous to transmit only difference between consecutive images. The difference frame, called prediction error frame Eₙ, is the difference between the current frame Iₙ and the reference frame Pₙ, one of the previously coded frames. The prediction error frame is thus
Eₙ(x,y)=Iₙ(x,y)−Pₙ(x,y).
where n is the frame number and (x, y) represents pixel coordinates. In a typical video codec, the prediction error frame is compressed before transmission. Compression is achieved by means of Discrete Cosine Transform (DCT) and Huffman coding, or similar methods.

Since video to be compressed contains motion, subtracting two consecutive images does not always result in smallest difference. For example, when camera is panning, the whole scene is changing. To compensate the motion, a displacement (Δx(x, y),Δy(x, y)), called motion vector, is added to the coordinates of the previous frame. Thus prediction error becomes
Eₙ(x,y)=Iₙ(x,y)−Pₙ(x+Δx(x, y),y+Δy(x, y)).
Any pixel of the previous frame can be subtracted from the pixel in the current frame and thus prediction error is smaller. However, having motion vector for every pixel is not practical because this motion vector then has to be transmitted for every pixel. In practice, the frame in the video codec is divided into blocks and only one motion vector for each block is transmitted, so that the same motion vector is used for all the pixels within one block. To further minimize the number of bits needed to represent motion vector for a given block, only the delta vector is coded, i.e., difference between this motion vector and the so-called predictive motion vector.

In non-scalable (single layer) coders the predictive motion vector for a block to be coded is usually calculated using motion vectors of its neighboring blocks (neighboring motion vectors) as, for example, a median of these vectors. This is shown in FIG. 1. The current block's immediate left, up, up-right and up-left blocks are checked and their motion vectors are used to form predictive motion vector in the process called motion vector prediction. In FIG. 1, the current block x can be variable, but the neighboring blocks a, b, c, d must have a size of 4×4, according to AVC standard. Here, it is assumed that all 4×4 blocks within a macroblock partition are filled with the same motion information (which includes macroblock partition prediction mode, reference frame index, motion vector, etc) for that macroblock partition.

In scalable video coding, there are a number of coding layers. For example, the coding layers include a base layer and an enhancement layer, which enhances the spatial resolution, temporal resolution or picture quality relative to the base layer. In the discussion below, the term “base layer” could be the absolute base layer that is generated by a non-scalable codec such as H.264, or an enhancement layer that is used as the basis in encoding the current enhancement layer. In scalable video coding, in addition to the spatially neighboring motion vectors from the current layer, vectors from the base layer may also be available and used for motion vector prediction.

When the current layer is an enhancement layer in terms of video temporal resolution or picture quality, it has the same frame size as that of its base layer. In this case, base layer motion vectors can be used directly for current layer motion prediction. However, when the current layer is a spatial resolution enhancement layer, it has a different frame size from its base layer. In such case, motion vectors from base layer need to be properly up-sampled and the blocks to which they correspond need to be scaled before they can be used for current layer motion prediction. For example, if the current layer has a spatial resolution two times the spatial resolution of its base layer, along both horizontal direction and vertical direction, block sizes and motion vectors of the base layer should be up-sampled by two along each direction before they are used for current layer motion prediction.

In the following description, when a motion vector from a spatial base layer is used, it is assumed that such kind of motion vector up-sampling has been performed even if it's not explicitly mentioned. Furthermore, when a motion vector at a certain block position is said to be “not available”, it means that the block is outside the picture boundary or the block is intra coded.

For a motion vector, there is also a reference frame index associated with it. This index indicates the frame number of the reference frame that this motion vector is referring to.

For motion vector prediction at an enhancement layer, how to efficiently and reliably utilize motion vectors from the base layer in addition to those from the current layer is the key for a successful motion vector prediction. A predictive motion vector can be formed from the current layer motion vectors or the base layer motion vectors or a combination of these two.

In an HHI codec as described in ISO/IEC JTC 1/SC 29/JWG 11 N6716 released in MPEG meeting in October 2004, Spain, two types of predictive motion vectors can be calculated and the better one is chosen. The first type is calculated using the neighboring motion vectors from the current layer, and the second type is equal to the co-located base layer motion vector. In the HHI codec, co-located base layer motion vector is the motion vector of the base layer block, which has the same upper-left corner as the block in the current layer, e.g., in FIG. 2(a) it is motion vector of block 1. Such prediction is performed on a macroblock partition basis. (As shown in FIG. 2 in AVC/H.264 standard, a macroblock partition can be in the size of 16×16, 16×8, 8×16 and 8×8. Vectors in a macroblock partition all have the same reference frame index and prediction mode, i.e. forward prediction, backward prediction or bidirectional prediction). For each macroblock partition, up to two motion prediction flags (depending on the prediction mode) are transmitted to indicate from which layer predictive motion vector is derived. The advantage of this method is that it chooses the better prediction for each macroblock partition. Its disadvantage is the overhead of encoding flag bits for each macroblock partition.

Some other coders, e.g. the Poznan codec as described in a proposal ISO/IEC JTC1/SC29/WG11 MPEG2004/M10569/S13 (M10626) submitted by Poznan to 68^{th} MPEG meeting at Munich, March 2004, can avoid encoding flag bits by adaptively choosing a predictive motion vector among the current layer motion vectors as well as the base layer motion vector (selected in the same manner as in the HHI coder) based on some simple rules (tabularized). The rules are only taking into consideration the availability of neighboring vectors at the current layer. The advantage of this method is that it doesn't have the overhead of encoding flag bits. However, based on simple rules, there is no guarantee that the better prediction between current layer and base layer is chosen. As a result, prediction performance is sacrificed.

### SUMMARY OF THE INVENTION

The present invention improves traditional motion prediction schemes for use in scalable video coding by:
For each motion vector, calculating two predictive motion vectors, one from the current layer neighboring motion vectors and one from the co-located base layer motion vectors. One of the two predictive motion vectors is chosen as the predictive motion vector for the current block. A flag bit conditionally needs to be coded to indicate which layer the predictive motion vector for the current block comes from;
For a current block at the enhancement layer, when multiple co-located motion vectors are available at the base layer, those motion vectors are all considered in determining a predictive motion vector from the base layer that is to be used for current block motion prediction.
When it is possible to infer which layer the predictive motion vector for the current block comes from, the flag bit need not be coded. The following lists some of the situations when such inference is possible:
   1. The predictive motion vector from the current layer neighboring motion vectors is the same as the predictive motion vector from the co-located base layer motion vectors;
   2. The current layer neighboring motion vectors are unavailable, or the co-located base layer motion vectors are unavailable;
   3. The predictive motion vector from either the current layer or the base layer has a different reference frame index from the current motion vector;
   4. Based on certain criterions, predictive motion vector from either the current layer or the base layer is rejected. For example, motion prediction from the current layer can be rejected if those vectors lack consistency and, therefore, are not considered reliable to be used for motion prediction; and
   5. The predictive motion vector from the base layer is very close to the predictive motion vector from the current layer. This is a more general condition than condition 1.

### BRIEF DESCRIPTION OF THE DRAWINGS

FIG. 1 shows spatially neighboring motion vectors that are considered on the current layer. This is the same as that defined in AVC standard.

FIG. 2(a) shows an example of macroblocks on a base layer and a corresponding temporal or quality enhancement layer with mode 16×16.

FIG. 2(b) shows an example of macroblocks on a base layer and a corresponding temporal or quality enhancement layer with mode 8×16.

FIG. 2(c) shows an example of macroblocks on a base layer and a corresponding spatial enhancement layer with mode 16×16.

FIG. 2(d) shows an example of macroblocks on a base layer and a corresponding spatial enhancement layer with mode 16×8.

FIG. 3 shows an exemplary system in which embodiments of the present invention can be utilized.

FIG. 4 is a block diagram showing an exemplary video encoder in which embodiments of the present invention can be implemented.

FIG. 5 is a block diagram showing an exemplary video decoder in which embodiments of the present invention can be implemented.

FIG. 6 is a flowchart showing the method of determining whether a flag bit needs to be coded.

FIG. 7 is a block diagram showing a layered scalable video encoder in which embodiments of the present invention can be implemented.

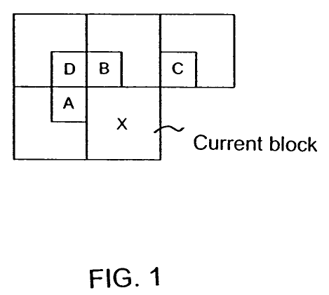

### DETAILED DESCRIPTION OF THE INVENTION

The present invention generally involves the following steps:

Obtaining a Predictive Motion Vector from a Base Layer

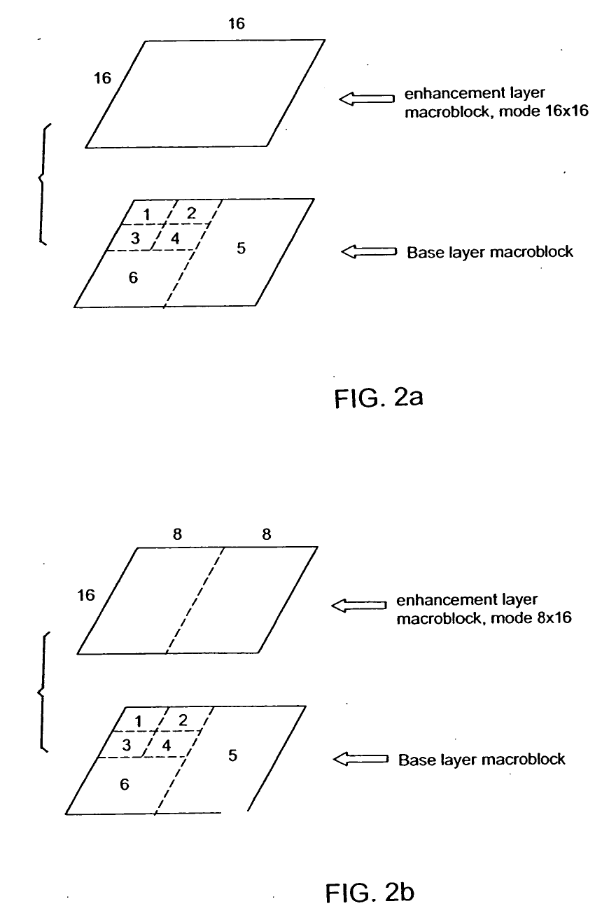

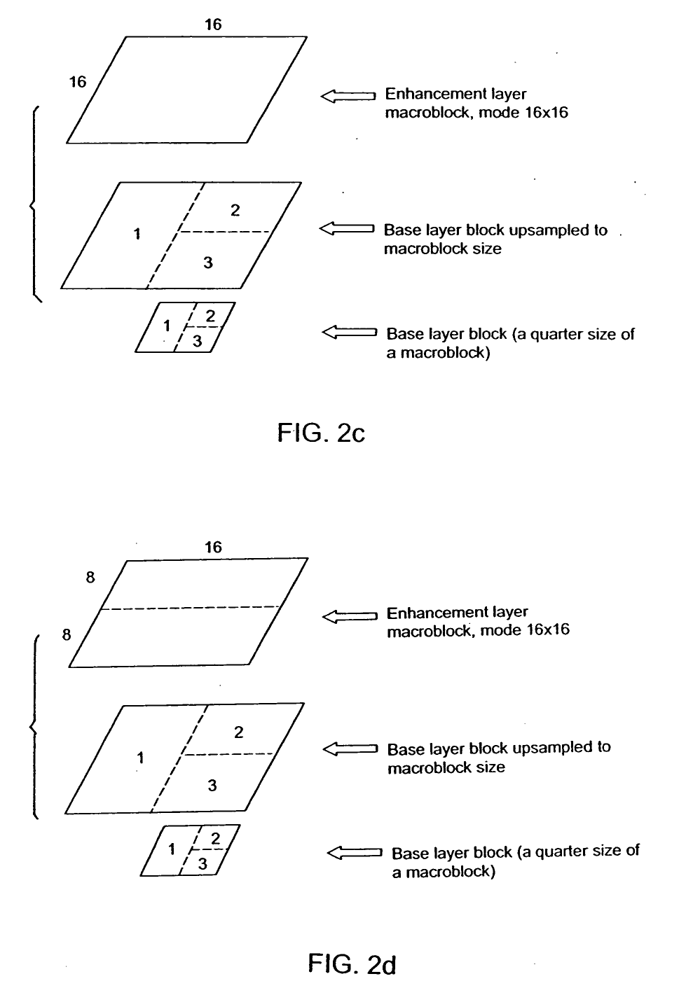

When there is only one co-located base layer motion vector for the current block, that vector is used as the predictive motion vector from the base layer for the current block. When there are multiple co-located motion vectors available at the base layer for the current block, they are all taken into consideration for determining a predictive motion vector from the base layer that is to be used for the current block motion prediction. An example of multiple co-located base layer motion vectors is shown in FIG. 2 (a). As shown in FIG. 2(a), the block partition mode in the enhancement layer macroblock is 16×16. In that case, all the six motion vectors corresponding to the six blocks in the base layer macroblocks are considered as the co-located motion vectors for the current 16×16 block. If the block partition mode in the enhancement layer macroblock is 8×16 as shown in FIG. 2(b), then the left 8×16 block has five co-located motion vectors from the base layer macroblock and the right 8×16 has one co-located motion vector from the base layer macroblock.

When the current block is a spatial resolution enhancement layer, each macroblock of the current layer may correspond to, for example, a quarter size area in a macroblock on the base layer. In this case, the quarter size macroblock area on the base layer should be up-sampled to the macroblock size and the corresponding motion vectors are up-scaled by two as well. Depending on the block partition mode of the macroblock on the current layer, there may be multiple co-located motion vectors available at the base layer. For example, if the block partition mode in the enhancement layer macroblock is 16×16 as shown in FIG. 2(c), then all three motion vectors corresponding to the three blocks in the base layer are considered as the co-located motion vectors for the current 16×16 block. Likewise, if the block partition mode in the enhancement layer macroblock is 16×8, as shown in FIG. 2(d), then the upper 16×8 block of the enhancement layer macroblock has two co-located motion vectors from the base layer, one from block 1 and one from block 2. The lower 16×8 block of the enhancement layer macroblock has two co-located motion vectors from the base layer, one from block 1 and one from block 3.

When there are multiple co-located motion vectors available from the base layer for the current block, their reference frame indices are checked and each motion vector is associated with a reference frame index. The reference frame index indicates the frame number of the reference frame that this motion vector is referring to. Priority is given to the motion vectors with the same reference frame index as the current block being coded. If the co-located motion vectors available on the base layer have the same reference frame index as the current block, these motion vectors are used to calculate the final base layer vector. The calculation can be carried out in a number of ways. For example, an average of the vectors with the same reference frame index as the current block can be taken as the final base layer motion vector. Alternatively, a median can be used in calculating the final base layer motion vector from these multiple co-located motion vectors with the same reference frame index as the current block. The reference frame index of the final base layer motion vector may be set to the same as the current block. The final base layer vector is used as the predictive motion vector from the base layer for the current block.

When calculating the average or median of multiple co-located base layer motion vectors, the block partition size of the motion vector may be taken into consideration. For example, motion vectors with a larger block size can be given greater weight in the calculation. For example, referring back to FIG. 2(a), if all six motion vectors, (Δx₁,Δy₁), (Δx₂,Δy₂), . . . , (Δx₆,Δy₆) corresponding to each block, are used to calculate a final base layer motion vector (Δx₅,Δy₅) can be given eight times the weight as those in blocks 1, 2, 3 and 4. Similarly, motion vector (Δx₆,Δy₆) can be given four times the weight as those in the blocks 1, 2, 3 and 4.

Obtaining a Predictive Motion Vector from Current Layer

The method of obtaining a predictive motion vector from the current layer is the same as that in standard AVC. In addition, certain conditions of the current layer neighboring motion vectors can also be checked. For example, the conditions are the motion vector consistency and the motion vector reliability.

The similarity or consistency of the neighboring motion vectors may be checked at the current layer in order to determine whether the current layer motion vectors may be used to calculate the predictive motion vector. When neighboring motion vectors are similar to each other, they are considered to be better candidates to be used for motion vector prediction.

Checking the similarity or consistency of the neighboring motion vectors can be carried out in a number of ways. For example, vector distance can be used as a measure of similarity or consistency of the neighboring motion vectors. As an example, let the predictive motion vector obtained using motion vectors (Δx₁,Δy₁), (Δx₂,Δy₂), . . . , (Δxₙ,Δyₙ) be denoted by (Δxₚ,Δyₚ). A measure of consistency can be defined as the sum of the squared differences between these vectors (Δx₁,Δy₁), (Δx₂,Δ₂), . . . , (Δxₙ, Δyₙ) and the predictive motion vector (Δxₚ,Δyₚ).

The reliability of motion vector prediction using neighboring vectors at a base layer may be checked to indicate whether it is reliable to use the current layer motion vectors to calculate the predictive motion vector. The reliability of motion vector prediction may be checked in a number of ways. For example, the reliability can be measured as a difference (delta vector) between the predictive motion vector and the coded motion vector for the co-located block in the base layer. If the predictive motion vector calculated using neighboring vectors at the base layer is not accurate for the base layer, it is likely that the predictive motion vector so calculated is not be accurate for the currently layer.

Choosing the Better Predictive Motion Vector

In general, the predictive motion vector from base layer and the predictive motion vector from the current layer are both checked and the one that gives a better (or more accurate) prediction is selected as the predictive motion vector for the current block. One or two flag bits (depending on uni-directional prediction or bi-directional prediction) need to be coded for the current block. However, when it is possible to infer the layer from which the predictive motion vector for the current block comes, the flag bit need not be coded in order to reduce the overhead.

Reducing the Overhead of Encoding Flag Bits

Flag bits indicating which layer motion vectors are chosen to derive the predictive motion vector for the current block are coded only when necessary. Flag bits are not coded when it can be inferred from the already coded information which layer motion vectors are chosen to derive predictive motion vector for the current block. Such inference is possible in the following exemplary situations:
1. When the predictive motion vector obtained from the current layer is the same as the predictive motion vector obtained from base layer, it doesn't matter which one is chosen. In this case, flag bits need not be coded. Either one of the two predictive motion vectors can be used as the final predictive motion vector for the current block.
2. When only one of the two predictive motion vectors, one from the current layer and one from base layer, is available, it is certain that the available one will be chosen. In such case, flag bits need not be coded.
3. When the two predictive motion vectors, one from the current layer and one from the base layer, are all available but one of them has a different reference frame index from the current motion vector, then the one with the same reference frame index as the current motion vector is chosen as the predictive motion vector for the current block. In such case, flag bits need not be coded.
4. When the predictive motion vector from either the current layer or the base layer is considered unreliable and thus rejected, the predictive motion vector from the other layer is chosen. In such case, flag bits need not be coded.
5. Similarity between co-located base layer motion vectors and the current layer neighboring motion vectors can be used to reduce the overhead of coding flag bits. When the predictive motion vector from base layer (Δxₚ₁, Δyₚ₁) is very close to the predictive motion vector from the current layer (Δxₚ₂, Δyₚ₂), e.g., the difference between these two predictive motion vectors D((Δxₚ₁, Δyₚ₁), (Δxₚ₂, Δyₚ₂)) is not larger than a certain threshold T, flag bits need not be coded. Here D is a certain distortion measure. For example, it could be defined as the sum of the squared differences between the two vectors. The threshold T can be defined as a number, e.g. T=0, 1 or 2, etc. Tcan also be defined as a percentage number, such as within 1% of (Δxₚ₁, Δyₚ₁) or (Δxₚ₂, Δyₚ₂) etc. Some other forms of definition of T are also allowed. When T is equal to 0, it requires (Δxₚ₁, Δyₚ₁) and (Δxₚ₂, Δyₚ₂) be exactly the same, which is the case for the first situation listed above. When D((Δxₚ₁, Δyₚ₁), (Δxₚ₂, Δyₚ₂)) is not larger than T, the predictive motion vector for the current block can be determined with any of the following methods:
   the same as the predictive motion vector from the current block;
   the same as the predictive motion vector from the base layer;
   a combination of the two predictive motion vectors. For example, taking the average of the two predictive motion vectors.
      Second Embodiment of the Present Invention

Instead of on a motion vector basis, motion vector prediction is performed on macroblock partition basis. For each macroblock partition (16×16, 16×8, 8×16, 8×8), up to two motion vector prediction flags (depending on uni-directional prediction or bi-directional prediction) are determined. Except the case of 8×8 macroblock partition with further sub macroblock partitions (e.g. 4×8, 8×4 and 4×4 blocks), the same mechanism for reducing the overhead of encoding flag bits described above is applied. When the flag bit can be inferred, it need not be coded. For 8×8 macroblock partition with further sub macroblock partitions, motion prediction flag bits need to be coded.

Third Embodiment of the Present Invention

Motion vector prediction is performed on macroblock basis. For each macroblock (16×16 blocks defined in AVC), all motion vectors within this macroblock are predicted in the same way, i.e. either all predicted from the current layer, or all predicted from the base layer. In this case, only one flag bit needs to be coded indicating which layer motion vectors are used for motion prediction. In addition, for 16×16 macroblock partition, the same mechanism for reducing the overhead of encoding flag bits described above can be applied.

Fourth Embodiment of the Present Invention

All the motion prediction mechanisms described in the first, second and third embodiments above can be applied to a new macroblock coding mode to further improve the coding efficiency.

In scalable video coding, there is a special macroblock coding mode named “Mode Inheritance (MI) from base layer”. In general, when a scalable video codec is built on top of a single layer codec, in addition to the existing prediction modes already defined in the single layer coder, some new text prediction modes and syntax prediction modes are used to reduce the redundancy among the layers in order to achieve good efficiency. With the MI mode, it would not be necessary to code additional syntax elements for a macroblock except a flag (called MI flag), which is used for indicating that the mode decision of this macroblock can be derived from that of the corresponding macroblock in the base layer.

If the resolution of the base layer is the same as that of the enhancement layer, all the mode information can be used as is. If the resolution of the base layer is different from that of the enhancement layer (for example, half of the resolution of the enhancement layer), the mode information used by the enhancement layer needs to be derived according to the resolution ratio.

In this embodiment, a new macroblock coding mode can be created which is similar to MI mode but the new mode incorporates further motion search for motion refinement. This mode can be referred to as “Motion Refinement from base layer” mode or MR. In the MR mode, similar to MI mode, all the mode decision of the current macroblock except motion vectors can be derived from that of the corresponding macroblock in the base layer. This includes macroblock partition, partition prediction mode (i.e. forward, backward or bi-directional), motion vector reference frame indexes etc. Instead of directly using motion vectors from base layer, best motion vectors are searched based on the current macroblock partition inherited from base layer. All the motion prediction mechanisms described in the first, second and third embodiments of the present invention can be applied, which means that the predictive motion vector can be obtained from either the current layer or the base layer.

The MR mode is used only when base layer macroblock is inter-predicted (i.e. not intra coded macroblock). To code this macroblock mode, a flag bit (called MR bit) needs to be coded to indicate whether the current macroblock is in MR mode. In addition, new motion vectors also need to be coded. Motion prediction flag needs to be coded only conditionally to indicate which layer (current layer or base layer) motion vectors are used to derive predictive motion vector.

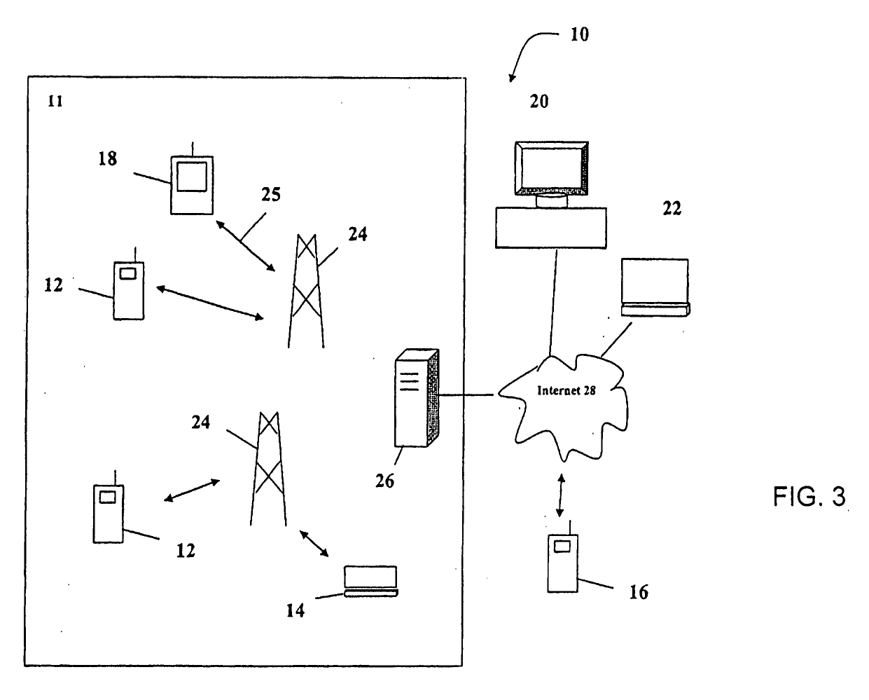

Embodiments of the present invention may be used in a variety of applications, environments, systems and the like. For example, FIG. 3 shows an example system 10 in which embodiments of the present invention may be utilized. The system 10 shown in FIG. 3 may include multiple communication devices that can communicate through a network, such as cellular or mobile telephones 12 and 14, for example. The system 10 may include any combination of wired or wireless networks including, but not limited to, a cellular telephone network, a wireless Local Area Network (LAN), a Bluetooth personal area network, an Ethernet LAN, a token ring LAN, a wide area network, the internet and the like. The system 10 may include both wired and wireless communication devices.

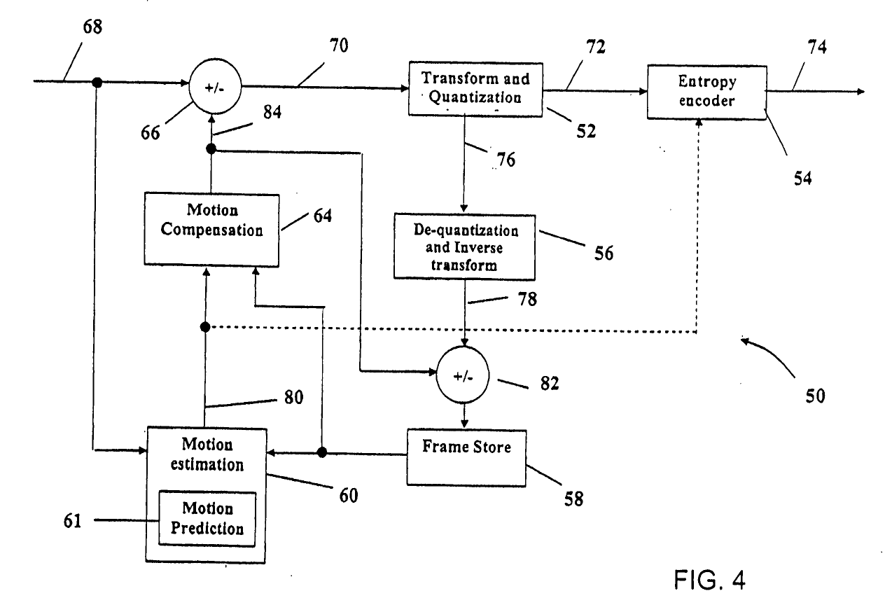

FIG. 4 is a block diagram of an example video encoder 50 in which embodiments of the present invention may be implemented. As shown in FIG. 4, the encoder 50 receives input signals 68 indicating an original frame and provides signals 74 indicating encoded video data to a transmission channel (not shown). The encoder 50 may include a motion estimation block 60 to carry out motion estimation across multiple layers and generate a set of predications. Resulting motion data 80 is passed to a motion compensation block 64. The motion compensation block 64 may form a predicted image 84. As the predicted image 84 is subtracted from the original frame by a combining module 66, the residuals 70 are provided to a transform and quantization block 52 which performs transformation and quantization to reduce the magnitude of the data and send the quantized data 72 to a de-quantization and inverse transform block 56 and an entropy coder 54. A reconstructed frame is formed by combining the output from the de-quantization and inverse transform block 56 and the motion compensation block 64 through a combiner 82. After reconstruction, the reconstructed frame may be sent to a frame store 58. The entropy encoder 54 encodes the residual as well as motion data 80 into encoded video data 74.

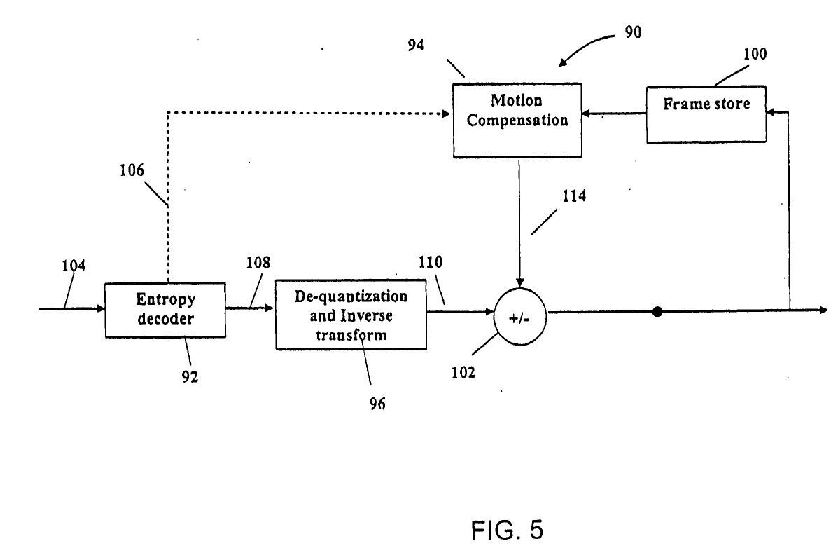

FIG. 5 is a block diagram of an example video decoder 90 in which embodiments of the present invention may be implemented. In FIG. 5, a decoder 90 may use an entropy decoder 92 to decode video data 104 from a transmission channel into decoded quantized data 108. Motion data 106 is also sent from the entropy decoder 92 to a de-quantization and inverse transform block 96. The de-quantization and inverse transform block 96 may then convert the quantized data into residuals 110. Motion data 106 from the entropy decoder 92 is sent to the motion compensation block 94 to form predicted images 114. With the predicted image 114 from the motion compensation block 94 and the residuals 110 from the de-quantization and inverse transform block 96, a combination module 102 may provide signals 118 that indicate a reconstructed video image.

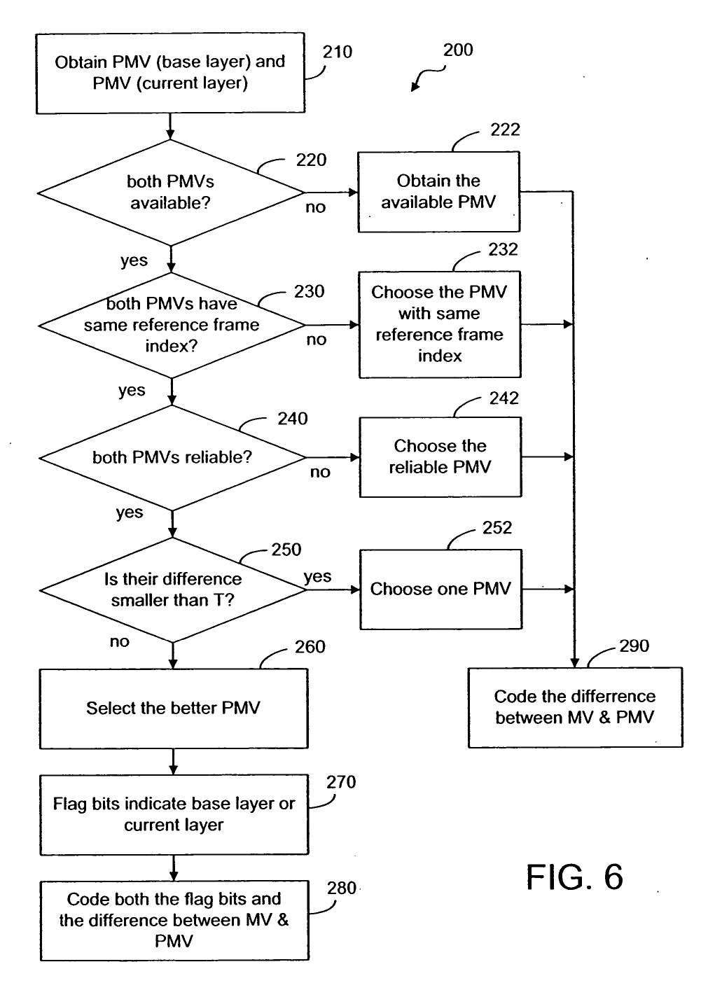

The method of motion vector prediction can be summarized in the flowchart as shown in FIG. 6. As shown in the flowchart 200, the predictive motion vectors are obtained at step 210 from both the current layer and from the base layer, if available. At step 220, if only one of the predictive motion vector from the current layer and the predictive motion vector from the base layer is available, obtain the available one at step 222 and code the difference between the current motion vector and the available predictive motion vector at step 290. At step 230, if only one predictive motion vector has the same reference index as the current motion vector, choose that predictive motion vector at step 232 and code the difference between the current motion vector and the chosen predictive motion vector at step 290 . At step 240, if only one of the predictive motion vectors is reliable, choose the reliable one at step 242 and code the difference between the current motion vector and the chosen predictive motion vector at step 290. At step 250, if the difference between the co-located base layer predictive motion vector and the predictive motion vector from the current layer is not larger than a predetermined value T, then choose either predictive motion vector or calculate one based on both predictive motion vectors at step 252 and code the difference between the current motion vector and the chosen or calculated predictive motion vector at step 290. But if both predictive motion vectors are available, reliable and having the same reference frame index but they are not similar, choose the better predictive motion vector at step 260; indicate which predictive motion vector is used in the flag bits at step 270 and code both the flag bits and the difference between the current motion vector and the predictive motion vector at step 280.

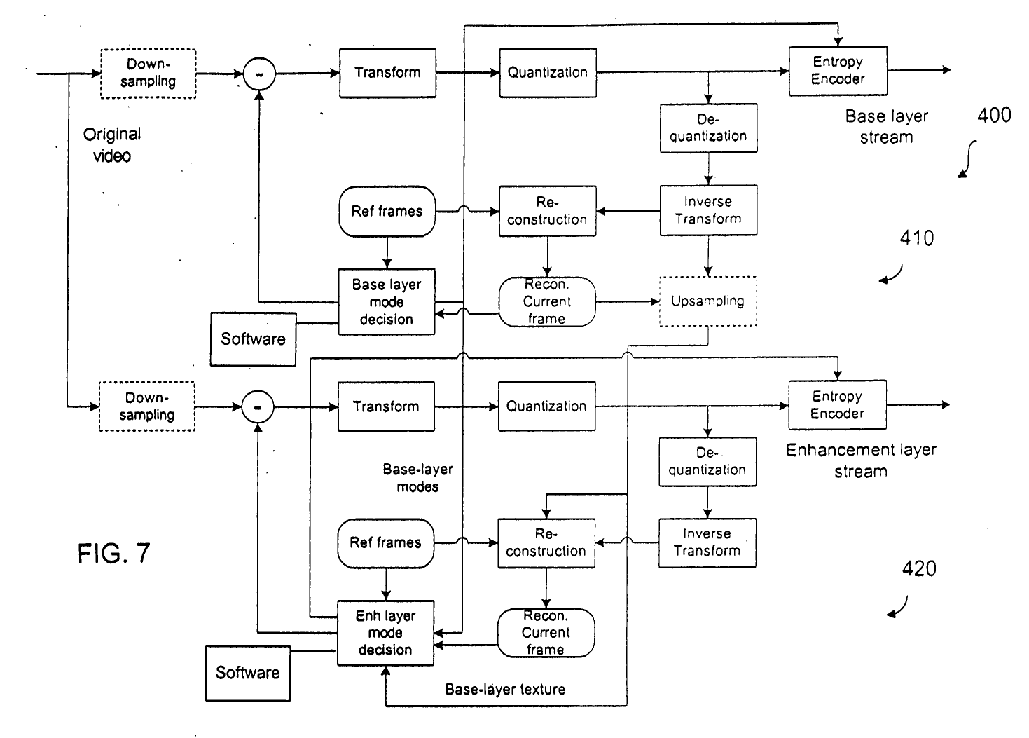

FIG. 7 shows a block diagram of a scalable video encoder 400 in which embodiments of the present invention can be implemented. As shown in FIG. 7, the encoder has two coding modules 410 and 420 each of the modules has an entropy encoder to produce a bitstream of a different layer. It is understood that the encoder 400 comprises a software program for determining how a coefficient is coded. For example, the software program comprises a pseudo code for calculating two predictive motion vectors, one from the current layer neighboring motion vectors and one form the co-located base layer motion vectors, and a pseudo code for choosing on of the two predictive motion vector as the predictive motion vector for the current block. As such, a flag bit may or may not be coded to indicate which predictive motion vector is chosen.

In sum, the present invention provides a method and a video coder for use in scalable video coding for motion vector prediction in an enhancement layer in a video frame, the enhancement layer having a corresponding base layer, wherein the enhancement layer comprises a plurality of first blocks including a current block and a plurality of neighboring blocks, and the base layer comprises a plurality of second blocks corresponding to the current block. The invention is concerned with computing a first predictive motion vector of the current block, if available, based at least on motion vectors in the neighboring blocks, and computing a second predictive motion vector of the current block, if available, based at least on a motion vector in the corresponding second blocks; and wherein the difference between the current block motion vector and one of the available predictive motion vectors is coded for providing at least a difference motion vector, so that the available one predictive motion vector is used to predict motion associated with the enhancement layer in a decoding process based on the difference motion vector.

In particular, the first predictive motion vector is associated with a first reference frame index, the second predictive motion vector is associated with a second reference frame index, the current block motion vector is associated with a third reference frame index and wherein when both the first predictive motion vector and the second predictive motion vector are available, and if one and only one of the first and second reference frame indices is the same as the third reference frame index, further steps are carried out:
coding the difference between the current block motion vector and one of the first and second predictive motion vector associated with the same reference frame index as the third reference frame index for providing the difference motion vector, and
using said one of the first and second predictive motion vector associated with the same reference frame index as the third reference frame index to predict the motion associated with the enhancement layer in a decoding process based on the difference motion vector.

According to the present invention, when both the first predictive motion vector and the second predictive motion vector are available, further steps are carried out:
computing a first difference vector associated with the first predictive motion vector, the first difference vector having a first amplitude;
computing a second difference vector associated with the second predictive motion, the second difference vector having a second amplitude; and
if the first amplitude is smaller than the second amplitude, coding the difference between the current block motion vector and the first predictive motion vector for providing a difference motion vector, and
if the second amplitude is smaller than the first amplitude, coding the difference between the current block motion vector and the second predictive motion vector for providing the difference motion vector.

Alternatively, if the second amplitude is greater than a predetermined value, coding the difference between the current block motion vector and the first predictive motion vector to obtain a difference motion vector.

Alternatively, a difference value between the first predictive motion vector and the second predictive motion vector is computed, use the first predictive motion vector to predict the motion associated with the enhancement layer in the decoding process based on the coded difference between the current block motion vector and the first predictive motion vector if the difference value is within a predetermined range, or use the second predictive motion vector to predict the motion associated with the enhancement layer in the decoding process based on the coded difference between the current block motion vector and the second predictive motion vector if the difference value is within a predetermined range.

Alternatively, computing the difference between the current block motion vector and a combination of the first and second predictive vectors to predict the motion associated with the enhancement layer in the decoding process based on the coded difference between the current block motion vector and said combination if the difference value is within a predetermined range. The combination is an average of the first and second predictive vectors.

Alternatively, selecting one of the first and second predictive motion vectors based on a rate-distortion measure associated with the first and second predictive motion vectors for predicting the motion with the enhancement layer in the decoding process; and coding the difference between the current block motion vector and said selected one predictive motion vector as well as coding a flag bit indicating the selection between the first and second predictive motion vectors so that said selected one predictive motion vector is used to predict the motion associated with the enhancement layer in the decoding process.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for use in scalable video coding for motion vector prediction in an enhancement layer in a video frame, the enhancement layer having a corresponding base layer, wherein the enhancement layer comprises a plurality of first blocks including a current block and a plurality of neighboring blocks, and the base layer comprises a plurality of second blocks corresponding to the current block, said method comprising the steps of:
computing a first predictive motion vector of the current block, if available, based at least on motion vectors in the neighboring blocks;
computing a second predictive motion vector of the current block, if available, based at least on a motion vector in the corresponding second blocks; and
coding the difference between the current block motion vector and one of the available predictive motion vectors for providing at least a difference motion vector, so that the available one predictive motion vector is used to predict motion associated with the enhancement layer in a decoding process based on the difference motion vector.

2. The method of claim 1, wherein the first predictive motion vector is associated with a first reference frame index, the second predictive motion vector is associated with a second reference frame index, the current block motion vector is associated with a third reference frame index and wherein when both the first predictive motion vector and the second predictive motion vector are available, and if one and only one of the first and second reference frame indices is the same as the third reference frame index, said method further comprising the steps of:
coding the difference between the current block motion vector and one of the first and second predictive motion vector associated with the same reference frame index as the third reference frame index for providing the difference motion vector, and
using said one of the first and second predictive motion vector associated with the same reference frame index as the third reference frame index to predict the motion associated with the enhancement layer in a decoding process based on the difference motion vector.

3. The method of claim 1, wherein both the first predictive motion vector and the second predictive motion vector are available, said method further comprising the steps of:
computing a first difference vector associated with the first predictive motion vector, the first difference vector having a first amplitude;
computing a second difference vector associated with the second predictive motion, the second difference vector having a second amplitude; and
if the first amplitude is smaller than the second amplitude, coding the difference between the current block motion vector and the first predictive motion vector for providing a difference motion vector, and
if the second amplitude is smaller than the first amplitude, coding the difference between the current block motion vector and the second predictive motion vector for providing the difference motion vector.

4. The method of claim 1, wherein both the first predictive motion vector and the second predictive motion vector are available, said method further comprising the steps of:
obtaining a difference vector associated with the second predictive motion, the difference vector having an amplitude; and
if the amplitude is greater than a predetermined value, coding the difference between the current block motion vector and the first predictive motion vector to obtain a difference motion vector.

5. The method of claim 1, wherein both the first predictive motion vector and the second predictive motion vector are available, said method further comprising:
computing a difference value between the first predictive motion vector and the second predictive motion vector; and
using the first predictive motion vector to predict the motion associated with the enhancement layer in the decoding process based on the coded difference between the current block motion vector and the first predictive motion vector if the difference value is within a predetermined range.

6. The method of claim 1, wherein both the first predictive motion vector and the second predictive motion vector are available, said method further comprising:
computing a difference value between the first predictive motion vector and the second predictive motion vector; and
using the second predictive motion vector to predict the motion associated with the enhancement layer in the decoding process based on the coded difference between the current block motion vector and the second predictive motion vector if the difference value is within a predetermined range.

7. The method of claim 1, wherein both the first predictive motion vector and the second predictive motion vector are available, said method further comprising:
computing a difference value between the first predictive motion vector and the second predictive motion vector; and
computing the difference between the current block motion vector and a combination of the first and second predictive vectors to predict the motion associated with the enhancement layer in the decoding process based on the coded difference between the current block motion vector and said combination if the difference value is within a predetermined range.

8. The method of claim 6, wherein said combination is an average of the first and second predictive vectors.

9. The method of claim 1, wherein both the first predictive motion vector and the second predictive motion vector are available, said method further comprising:
selecting one of the first and second predictive motion vectors based on a rate-distortion measure associated with the first and second predictive motion vectors for predicting the motion with the enhancement layer in the decoding process; and
coding the difference between the current block motion vector and said selected one predictive motion vector as well as coding a flag bit indicating the selection between the first and second predictive motion vectors so that said selected one predictive motion vector is used to predict the motion associated with the enhancement layer in the decoding process.

10. A scalable video coding for coding a video sequence having a plurality of frames, each frame having a plurality of layers, said plurality of layers including a base layer and at least one enhancement layer, said enhancement layer comprising a plurality of first blocks including a current block and a plurality of neighboring blocks, the base layer comprising a plurality of second blocks corresponding to the current block, said encoder comprising:
means, responsive to the motion vectors in the neighboring block, for computing a first predictive motion vector of the current block, if available, based at least on motion vectors in the neighboring blocks;
means, responsive to a motion vector in the corresponding second blocks, for computing a second predictive motion vector of the current block, if available, based at least on the motion vector in the corresponding second blocks; and
means for coding the difference between the current block motion vector and one of the available predictive motion vectors for providing at least a difference motion vector, so that the available one predictive motion vector is used to predict motion associated with the enhancement layer in a decoding process based on the difference motion vector.

11. The encoder of claim 10, wherein the first predictive motion vector is associated with a first reference frame index, the second predictive motion vector is associated with a second reference frame index, the current block motion vector is associated with a third reference frame index and wherein when both the first predictive motion vector and the second predictive motion vector are available, and if one and only one of the first and second reference frame indices is the same as the third reference frame index, said coding means further coding the difference between the current block motion vector and one of the first and second predictive motion vector associated with the same reference frame index as the third reference frame index for providing the difference motion vector, and using said one of the first and second predictive motion vector associated with the same reference frame index as the third reference frame index to predict the motion associated with the enhancement layer in a decoding process based on the difference motion vector.

12. The encoder of claim 11, wherein both the first predictive motion vector and the second predictive motion vector are available, said encoder further comprising:
means for a first difference vector associated with the first predictive motion vector and a second difference vector associated with the second predictive motion vector, the first difference vector having a first amplitude, the second difference vector having a second amplitude; and
if the first amplitude is smaller than the second amplitude, coding the difference between the current block motion vector and the first predictive motion vector for providing a difference motion vector, and
if the second amplitude is smaller than the first amplitude, coding the difference between the current block motion vector and the second predictive motion vector for providing the difference motion vector.

13. The encoder of claim 11, wherein both the first predictive motion vector and the second predictive motion vector are available, said encoder further comprising:
means for obtaining a difference vector associated with the second predictive motion, the difference vector having an amplitude; and
if the amplitude is greater than a predetermined value, coding the difference between the current block motion vector and the first predictive motion vector to obtain a difference motion vector.

14. The encoder of claim 11, wherein both the first predictive motion vector and the second predictive motion vector are available, and wherein a difference value between the first predictive motion vector and the second predictive motion vector is computed; and, the difference between the current block motion vector and a combination of the first and second predictive vectors is computed so as to predict the motion associated with the enhancement layer in the decoding process based on the coded difference between the current block motion vector and said combination if the difference value is within a predetermined range.

15. The encoder of claim 14, wherein said combination is an average of the first and second predictive vectors.

16. The encoder of claim 11, wherein both the first predictive motion vector and the second predictive motion vector are available, said encoder further comprising:
means for selecting one of the first and second predictive motion vectors based on a rate-distortion measure associated with the first and second predictive motion vectors for predicting the motion with the enhancement layer in the decoding process; and said coding means codes the difference between the current block motion vector and said selected one predictive motion vector as well as coding a flag bit indicating the selection between the first and second predictive motion vectors so that said selected one predictive motion vector is used to predict the motion associated with the enhancement layer in the decoding process.

17. A software application product comprising a storage medium having a software application for use in coding a video sequence having a plurality of frames, each frame having a plurality of layers, said plurality of layers including a base layer and at least one enhancement layer, said enhancement layer comprising a plurality of first blocks including a current block and a plurality of neighboring blocks, the base layer comprising a plurality of second blocks corresponding to the current block, said application product having program codes for carrying out the method steps of claim 1.
